(19) United States
(12) Patent Application Publication
(10) Pub. No.: US 2014/0093614 A1
(43) Pub. Date: Apr. 3, 2014

(54) PROBIOTIC STABILIZATION

(71) Applicant: MEAD JOHNSON NUTRITION COMPANY, Glenview, IL (US)

(72) Inventors: Juan Gonzalez, Newburgh, IN (US); Bolivar Cevallos, Newburgh, IN (US); Bhavini Shah, Evansville, IN (US); Minhthy Nguyen, Evansville, IN (US)

(21) Appl. No.: 14/098,569

(22) Filed: Dec. 6, 2013

Related U.S. Application Data
(63) Continuation-in-part of application No. 12/563,157, filed on Sep. 20, 2009.

(51) Int. Cl. A23L 1/30; A23L 1/29

(52) U.S. Cl. CPC A23L 1/3014; A23L 1/296
USPC 426/61

(57) ABSTRACT

An ingestible composition including a probiotic contained in a mixture of a phospholipid and a glyceride, useful for nutrition of infants and children.

### TECHNICAL FIELD

The present disclosure relates to the stabilization of biological material for ingestion by an individual. More particularly, the present disclosure relates to a stabilization mixture comprising at least one phospholipid and at least one glyceride, which together provide improved stability to a probiotic organism when the probiotic is included in a nutritional composition. The disclosure also includes probiotic stabilization methods.

### BACKGROUND ART

There are currently a variety of compositions for supplementing the nutrition of both humans and animals. These supplements may be provided to alter, reduce or increase the microflora within an individual's gut so as to cause a desired effect on digestion. Ideally, supplementation may cultivate an improved microflora for individuals, including humans, based upon the alteration of specific bacteria within the human's gastrointestinal (GI) tract. This style of supplementation may be conducted through the use of probiotics, which are understood to be live microorganisms, that when administered in effective amounts confer a health or nutritional benefit to the host. One of the more common types of probiotics is a lactic acid bacterium which is able to convert sugars and other carbohydrates into lactic acid. This conversion lowers the pH within the gut of the host and provides fewer opportunities for harmful organisms to grow and cause problems through gastrointestinal infections.

A common technological challenge is introducing probiotics into the host in an appropriate manner, both for the maintenance of the probiotics as well as for the health and enjoyment of an individual. Current technologies include the utilization of encapsulation and stabilization techniques for shielding the probiotics with a protective layer or matrix so that the protected microbe may pass to the appropriate location within the individual's GI tract.

Although there have been developments concerning encapsulation and stabilization techniques for containing microorganisms for delivery into the digestive system of animals, there has been little development in encapsulation or stabilization techniques that protect the viability of probiotics during distribution and storage. There is a need for a stabilization technique that is useful where circumstances preclude refrigeration, and further where such formulations may be exposed to various environments, especially those associated with tropical climates. In addition, the inherent moisture of the product poses a challenge in that probiotics generally are sensitive to water, especially in combination with high temperature. To date, no technology or technique has been identified to deliver sufficient protection to probiotics under intermediate moisture conditions (i.e. water activity of about 0.2 and higher, and up to about 0.4 or higher) and high temperatures during distribution and storage (i.e. temperatures of at least about 30° C., and up to and above 40° C.) when incorporated into nutritional formulas.

In particular, probiotics can provide a variety of benefits to a host, such as maintaining a healthy gastrointestinal flora, enhancing immunity, protecting against diarrhea, atopic dermatitis and other diseases, etc. As such, there is a need for probiotics to be administered in various geographic locations, including tropical climates, where the viability of the probiotic could be compromised. Conventional encapsulation and stabilization techniques possess a chemical makeup that is ill-suited for infant formulas and/or for use by children, or known techniques have poor stability characteristics that significantly limit commercial opportunities.

What is desired therefore, is a stabilization technique and a stabilized bacterial mixture using acceptable ingredients for either an infant formula or children's nutrition, the stabilized mixture allowing for improved stability properties so that probiotics may be distributed in a wide variety of geographical locations and climates while maintaining a useful shelf-life. Further desired is a stabilization technology for the protection of probiotics, such as Lactobacillus rhamnosus, for use in nutritional compositions, such as infant formulas, supplements and children's products. Indeed, a combination of characteristics, including improved stability combined with nutritional factors, provide an improved stabilization mixture applicable for prenatal, infant, and children's nutrition.

### SUMMARY OF THE DISCLOSURE

In some embodiments, the present disclosure is directed to a nutritional composition comprising a protein source and a probiotic, wherein the probiotic is stabilized in a protective matrix, the protective matrix includes at least one phospholipid and at least one glyceride.

In such embodiments, the nutritional composition comprises viable microbial cells, such as viable Lactobacillus rhamnosus cells. Also, the matrix may comprise a source of hydrolyzed protein, pectin, an additional lipid, or any combination thereof. The nutritional composition may be a powdered formula, such as a powdered infant formula. Moreover, the at least one glyceride may include a monoglyceride, a diglyceride, or any combination thereof.

In another embodiment, the present disclosure is directed to a method for protecting a viable probiotic for use in a powdered nutritional composition, the method includes the steps of (i) providing a viable probiotic, (ii) preparing a protective matrix for the probiotic by blending together at least one phospholipid and at least one glyceride, and (iii) combining the viable probiotic, the protective matrix and water to produce a mixture; and (iv) drying the mixture of step (iii) to a final moisture content of about 4% or less. This method may comprise the additional step of a) adding the dried mixture to a powdered nutritional product or b) enclosing the dried mixture of step (iv) in a capsule. In such an embodiment, the viable probiotic may be Lactobacillus rhamnosus, Bifidobacterium longum BB536, Bifidobacterium longum subsp. infantis 35624, Bifidobacterium animalis subsp. lactis BB-12, or any combination thereof.

These aspects and others that will become apparent to the skilled artisan upon review of the following description can be accomplished by providing a mixture a phospholipid and a glyceride for the stabilization of biological material, such as probiotics, to provide for increased stability of the biological material, resulting in the improved, long-term viability of the biological material. In an embodiment, the stabilization mixture advantageously provides for an extension of the shelf-life of probiotics. The stabilization mixture may be combined with the probiotic in a variety of methods including freeze-drying, air-drying, vacuum-drying, spray-drying and any combination thereof for preserving the probiotic.

It is to be understood that both the foregoing general description and the following detailed description provide embodiments of the disclosure and are intended to provide an overview or framework of understanding to the nature and character of the disclosure as it is claimed.

### DETAILED DESCRIPTION

Reference now will be made in detail to the embodiments of the present disclosure, one or more examples of which are set forth hereinbelow. Each example is provided by way of explanation of the nutritional composition of the present disclosure and is not a limitation. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

Thus, it is intended that the present disclosure covers such modifications and variations as come within the scope of the appended claims and their equivalents. Other objects, features and aspects of the present disclosure are disclosed in or are obvious from the following detailed description. It is to be understood by one of ordinary skill in the art that the present discussion is a description of exemplary embodiments only and is not intended as limiting the broader aspects of the present disclosure.

The present disclosure provides a stabilization technique and a stabilized mixture (also referred to herein as a “stabilization mixture” or a “protective matrix”) that may be used for improving the stability of a biological material (also referred to herein as a “substrate”). In embodiments of the disclosure, the stabilized substrate may be a probiotic, wherein the various health benefits associated with the stabilized probiotic may be conferred to an individual upon ingesting a nutritional composition containing the stabilized probiotic.

While probiotics have been recognized as nutritionally beneficial, it is generally thought that the beneficial effects of probiotics are maximized if a probiotic microorganism is ingested by a subject when the microorganism is still alive. Thus, it is desirable for a viable probiotic to survive the conditions of manufacturing and of placement into a consumable nutritional composition, such as a food or beverage, as well as to survive the subsequent shipping and storage time before the product is ingested and introduced to a subject's gastrointestinal tract. Many conventional probiotic compositions utilize an extremely high count of viable cells, with the understanding that a significant number of cells ultimately lose viability and die during the manufacturing process, transport, and storage.

By practice of the present disclosure, a lipid component comprising at least one phospholipid and/or at least one glyceride is incorporated into a protective matrix. The phospholipid and/or glyceride increase the stability of probiotics that are protected by the matrix. As a result, infant- and children-compatible probiotics can be stabilized with a matrix including at least one phospholipid and/or at least one glyceride. In some embodiments, the matrix further comprises at least one additional lipid, that is, at least one lipid in addition to the phospholipid and glyceride. The stabilized probiotics can be used in multiple environments, as the probiotics exhibit an improved viability. Advantageously, probiotics stabilized by the protective matrix of the present disclosure can be incorporated into nutritional compositions and shipped over extended distances subjected to potentially damaging temperature fluctuations, as the probiotics will maintain viability even after extended transportation and storage time, due to the improved stability of the stabilized mixture.

The present method of providing stabilization to probiotics may include the use of a matrix for stabilizing a biological material, wherein the matrix includes a phospholipid, a glyceride, and additional components, such as one or more additional lipids, one or more carbohydrates and/or a compound binder.

While the protective matrix may be utilized for a variety of substances, in an embodiment, it is utilized to protect at least one probiotic, such as Lactobacillus rhamnosus. Lactobacillus rhamnosus is understood to possess relatively good bio-stability while having a high avidity for human intestinal mucosal cells. In use as a probiotic, Lactobacillus rhamnosus is thought to colonize the digestive tract and to balance intestinal microflora.

The protective matrix provides for improved stability of the probiotic, meaning that a greater percentage of the probiotic cells are viable after processing, transportation and storage conditions. Specifically, the shelf life of viable probiotics is improved when compared to other known stabilization techniques.

The protective matrix of the present disclosure may be used in a multiplicity of processes for forming a stabilized probiotic product. These processes include freezing, flash-freezing, freeze-drying, ambient air drying, vacuum drying, spray drying, low temperature drying, and any combination thereof. The resulting stabilized probiotic, whether alone or integrated into a nutritional composition, possesses effective viability in a wide range of temperatures and conditions while displaying improved shelf-life. Furthermore, the stabilized probiotic may be incorporated into a variety of prenatal, infant and children's nutritional products for improving their gut microflora while simultaneously providing nutrition to the infant or child.

Accordingly, in one embodiment, the disclosure is directed to a method for stabilizing a biological material in a nutritional composition. Still another embodiment is a protective matrix for a probiotic. A further embodiment is a method of increasing the shelf life of probiotics comprising stabilizing the probiotic with a stabilization mixture including a phospholipid, a glyceride or any combination thereof.

The present disclosure provides a novel stabilization mixture and method that provides stability and protection to biological materials, such as viable microorganisms. The present disclosure includes a stabilization mixture comprising a phospholipid, and a glyceride, which together provide a protective matrix resulting in an increased shelf-life over unprotected probiotics.

### DEFINITIONS

The terms “protective matrix,” “stabilization matrix,” and “stabilization mixture” are used interchangeably throughout the present disclosure.

An “effective amount” as used herein is generally defined as an amount of an agent that provides an observable result within the subject administered thereto.

“Nutritional composition” means a substance or formulation that satisfies at least a portion of a subject's nutrient requirements. The terms “nutritional(s)”, “nutritional formula (s)”, “enteral nutritional(s)”, and “nutritional supplement(s)” are used as non-limiting examples of nutritional composition(s) throughout the present disclosure. Moreover, “nutritional composition(s)” may refer to liquids, powders, gels, pastes, solids, concentrates, suspensions, or ready-to-use forms of enteral formulas, oral formulas, formulas for infants, formulas for pediatric subjects, formulas for children, growing-up milks and/or formulas for adults.

The term “enteral” means deliverable through or within the gastrointestinal or digestive tract. “Enteral administration” includes oral feeding, intragastric feeding, transpyloric administration, or any other administration into the digestive tract. “Administration” is broader than “enteral administration” and includes parenteral administration or any other route of administration by which a substance is taken into a subject's body.

“Pediatric subject” means a human less than 13 years of age. In some embodiments, a pediatric subject refers to a human subject that is less than 8 years old. In other embodiments, a pediatric subject refers to a human subject between 1 and 6 years of age. In still further embodiments, a pediatric subject refers to a human subject between 6 and 12 years of age.

“Infant” means a human subject ranging in age from birth to not more than one year and includes infants from 0 to 12 months corrected age. The phrase “corrected age” means an infant's chronological age minus the amount of time that the infant was born premature. Therefore, the corrected age is the age of the infant if it had been carried to full term. The term infant includes low birth weight infants, very low birth weight infants, and preterm infants. A “pre-term infant” is an infant born after less than about 37 weeks gestation. A “full-term infant” as used herein means an infant born after at least about 37 weeks gestation.

“Child” means a subject ranging in age from 12 months to about 12 years. In some embodiments, a child is a subject between the ages of 1 and 12 years old. In other embodiments, the terms “children” or “child” refer to subjects that are between one and about six years old, or between about seven and about 12 years old. In other embodiments, the terms “children” or “child” refer to any range of ages between 12 months and about 12 years.

“Children's nutritional product” refers to a composition that satisfies at least a portion of the nutrient requirements of a child. A growing-up milk (GUM) is an example of a children's nutritional product.

As used herein, “hydrolyzed protein” means a product of protein hydrolysis. Within the present disclosure, hydrolyzed protein and protein hydrolysate are used interchangeably to describe products of protein hydrolysis; extensively hydrolyzed protein is used to describe products of protein hydrolysis where at least 70%, more preferably at least about 90%, of the hydrolyzed protein has a molecular weight of less than 2000 Daltons.

The term “degree of hydrolysis” refers to the extent to which peptide bonds are broken by a hydrolysis method.

The term “protein-free” means containing no measurable amount of protein, as measured by standard protein detection methods such as sodium dodecyl (lauryl) sulfate-polyacrylamide gel electrophoresis (SDS-PAGE) or size exclusion chromatography. In some embodiments, the nutritional composition is substantially free of protein, wherein “substantially free” is defined hereinbelow.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

The term “growing-up milk” refers to a broad category of nutritional compositions intended to be used as a part of a diverse diet in order to support the normal growth and development of a child between the ages of about 1 and about 6 years of age.

“Milk-based” means comprising at least one component that has been drawn or extracted from the mammary gland of a mammal. In some embodiments, a milk-based nutritional composition comprises components of milk that are derived from domesticated ungulates, ruminants or other mammals or any combination thereof. Moreover, in some embodiments, milk-based means comprising bovine casein, whey, lactose, or any combination thereof. Further, “milk-based nutritional composition” may refer to any composition comprising any milk-derived or milk-based product known in the art.

“Nutritionally complete” means a composition that may be used as the sole source of nutrition, which would supply essentially all of the required daily amounts of vitamins, minerals, and/or trace elements in combination with proteins, carbohydrates, and lipids. Indeed, “nutritionally complete” describes a nutritional composition that provides adequate amounts of carbohydrates, lipids, essential fatty acids, proteins, essential amino acids, conditionally essential amino acids, vitamins, minerals and energy required to support normal growth and development of a subject.

The composition which is “nutritionally complete” for the preterm infant will, by definition, provide qualitatively and quantitatively adequate amounts of all carbohydrates, lipids, essential fatty acids, proteins, essential amino acids, conditionally essential amino acids, vitamins, minerals, and energy required for growth of the preterm infant. The composition which is “nutritionally complete” for the term infant will, by definition, provide qualitatively and quantitatively adequate amounts of all carbohydrates, lipids, essential fatty acids, proteins, essential amino acids, conditionally essential amino acids, vitamins, minerals, and energy required for growth of the term infant. The composition which is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child.

As applied to nutrients, the term “essential” refers to any nutrient that cannot be synthesized by the body in amounts sufficient for normal growth and to maintain health and that, therefore, must be supplied by the diet. The term “conditionally essential” as applied to nutrients means that the nutrient must be supplied by the diet under conditions when adequate amounts of the precursor compound is unavailable to the body for endogenous synthesis to occur.

The term “probiotic” means a microorganism with low or no pathogenicity that exerts beneficial effects on the health of the host. A “viable probiotic” means a live or active microorganism that exerts beneficial effects on the health of the host.

The term “inactivated probiotic” or “inactivated LGG” means a probiotic wherein the metabolic activity or reproductive ability of the referenced probiotic or Lactobacillus rhamnosus GG (LGG) organism has been reduced or destroyed. In an embodiment, the probiotic(s) may be viable or non-viable. As used herein, the term “viable”, refers to live microorganisms. The term “non-viable” or “non-viable probiotic” means non-living probiotic microorganisms, their cellular components and/or metabolites thereof. Such non-viable probiotics may have been heat-killed or otherwise inactivated, but they retain the ability to favorably influence the health of the host. The probiotics useful in the present disclosure may be naturally-occurring, synthetic or developed through the genetic manipulation of organisms, whether such source is now known or later developed.

“Prebiotic” means a non-digestible food ingredient that beneficially affects the host by selectively stimulating the growth and/or activity of one or a limited number of bacteria in the digestive tract that can improve the health of the host.

“Phytonutrient” means a chemical compound that occurs naturally in plants. Phytonutrients may be included in any plant-derived substance or extract. The term “phytonutrient(s)” encompasses several broad categories of compounds produced by plants, such as, for example, polyphenolic compounds, anthocyanins, proanthocyanidins, and flavan-3-ols (i.e. catechins, epicatechins), and may be derived from, for example, fruit, seed or tea extracts. Further, the term phytonutrient includes all carotenoids, phytosterols, thiols, and other plant-derived compounds.

“β-glucan” means all β-glucan, including specific types of β-glucan, such as β-1,3-glucan or β-1,3;1,6-glucan. Moreover, β-1,3;1,6-glucan is a type of β-1,3-glucan. Therefore, the term “β-1,3-glucan” includes β-1,3;1,6-glucan.

“Pectin” means any naturally-occurring oligosaccharide or polysaccharide that comprises galacturonic acid that may be found in the cell wall of a plant. Moreover, pectin may comprise molecules having a diverse chain length formed by D-galacturonopyranosyl. Different varieties and grades of pectin having varied physical and chemical properties are known in the art. Indeed, the structure of pectin can vary significantly between plants, between tissues, and even within a single cell wall. Generally, pectin is made up of negatively charged acidic sugars (galacturonic acid), and some of the acidic groups are in the form of a methyl ester group. The degree of esterification of pectin is a measure of the percentage of the carboxyl groups attached to the galactopyranosyluronic acid units that are esterified with methanol.

Pectin having a degree of esterification of less than 50% (i.e., less than 50% of the carboxyl groups are methylated to form methyl ester groups) are classified as low-ester, low methoxyl, or low methylated (“LM”) pectins, while those having a degree of esterification of 50% or greater than 50%, (i.e., more than 50% of the carboxyl groups are methylated) are classified as high-ester, high methoxyl or high methylated (“HM”) pectins. Very low (“VL”) pectins, a subset of low methylated pectins, have a degree of esterification that is less than approximately 15%. Furthermore, in some embodiments, pectin molecules have the ability to interact with themselves and/or with divalent cations, such as calcium, through electrostatic interactions to form high molecular weight networks and gels. The degree of esterification influences the extent of these intermolecular interactions.

“Lipid” refers to hydrophobic molecule(s) that may include free fatty acid(s) and/or molecules in which fatty acids are esterified to a hydroxyl group of (i) a saccharide, such as a mono- or di-saccharide, (ii) an alcohol, wherein the alcohol may comprise, for example, a long- or medium-carbon chain length (10-20 units), or (iii) a glycerol. These esterified or free fatty acids may be linear chains, saturated or unsaturated. Further, in some embodiments, the lipid component comprises glycerides, phospholipids, sphingosine-derived molecules, such as gangliosides, cerebrosides, and sphingomyelins, or any combination thereof. And in certain embodiments, the lipid component further includes molecules that are hydrophobic in nature, such as steroids, carotenoids, and/or fat-soluble vitamins.

“Glyceride” means any molecule derived from a glycerol or a sugar backbone in which one or more of the hydroxyl groups is esterified with a fatty acid. In some embodiments, the glyceride component comprises mono-glycerides, di-glycerides, mono-sugar esters, di-sugar esters, or a combination thereof.

“Phospholipid” means any molecule derived from a phosphatidic acid in which one or two carbons from the glycerol backbone are esterified to a fatty acid, and one of the terminal carbons is esterified to a phosphate group. In certain embodiments, the phosphate group is a phosphodiester also esterified to another functional molecule, such as choline, serine, or inositol. In some embodiments, the phospholipid component comprises glycerophospholipid and/or phosphoacylglycerols. Further, the phospholipid component may comprise lyso-phospholipids wherein one of the carbons from the glycerol backbone remains as a non-esterified hydroxyl group. And in some embodiments, the phospholipid component comprises lecithin, which may, for example, be extracted from soybeans or from egg yolk and may comprise a combination of phosphatidyl-choline, phosphatidyl-inositol and phosphatidyl serine. In some embodiments, the phospholipid may comprise soybean lecithin, egg lecithin, a milk fat derived phospholipid or a combination thereof.

All percentages, parts and ratios as used herein are by weight of the total nutritional composition, including the stabilized probiotic, unless otherwise specified.

All amounts specified as administered “per day” may be delivered in one unit dose, in a single serving or in two or more doses or servings administered over the course of a 24 hour period.

The nutritional composition of the present disclosure may be substantially free of any optional or selected ingredients described herein, provided that the remaining nutritional composition still contains all of the required ingredients or features described herein. In this context, and unless otherwise specified, the term “substantially free” means that the selected composition may contain less than a functional amount of the optional ingredient, typically less than 0.1% by weight, and also, including zero percent by weight of such optional or selected ingredient.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

As used herein, the term “about” should be construed to refer to both of the numbers specified as the endpoint(s) of any range. Any reference to a range should be considered as providing support for any subset within that range.

### The Protective Matrix

In the practice of the present disclosure, at least one phospholipid and at least one glyceride are utilized as components of a protective matrix for stabilizing biological material.

The use of the phospholipid and/or glyceride in the protective matrix of the present disclosure provides superior protection to probiotics, including Lactobacillus rhamnosus beyond what was previously known in the art.

The lipid component of the protective matrix may comprise, but is not limited to animal sources, e.g., milk fat, butter, butter fat, milk phospholipids, egg yolk lipid, egg yolk phospholipids; marine sources, such as fish oils, marine oils, single cell oils; vegetable and plant oils, such as corn oil, canola oil, sunflower oil, soybean oil, soybean phospholipids, palmolein, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

In some embodiments, the stabilization mixture comprises between about 0.5 and about 50 grams of a lipid component per 100 grams of the mixture on a dry basis. In certain embodiments, the stabilization mixture comprises between about 2.5 and about 30 grams of a lipid component per 100 grams of the mixture on a dry basis.

The stabilization mixture may comprise a phospholipid component. In certain embodiments, the stabilization mixture includes between about 0.5 and about 2 grams of a phospholipid component per 100 grams of the mixture on a dry basis. In some embodiments, the stabilization mixture comprises between about 0.75 and about 1.25 grams of a phospholipid component per 100 grams of the mixture on a dry basis.

Likewise, the stabilization mixture may include a glyceride component. In some embodiments, the stabilization mixture comprises between about 0.5 and about 2 grams of a glyceride component per 100 grams of the mixture on a dry basis. In certain embodiments, the stabilization mixture comprises between about 0.75 and about 1.25 grams of a glyceride component per 100 grams of the mixture on a dry basis. Moreover, the glyceride component may comprise monoglyceride(s), diglyceride(s), or any combination thereof.

In certain embodiments, the majority component of the stabilization mixture, based on a dry weight basis, is one or more carbohydrates, which may include polysaccharides, disaccharides and monosaccharides. Indeed, the protective matrix may include lactulose, lactosucrose, raffinose, gluco-oligosaccharide, trehalose, inulin, polydextrose, galacto-oligosaccharide, fructo-oligosaccharide, isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, gentio-oligosaccharides, and/or any combination thereof. In some embodiments, the protective matrix includes a first carbohydrate chosen from: sucrose, maltose, lactose, trehalose, maltotriose, maltodextrin having a dextrose equivalent of about 2 to about 6, and any combination thereof. In certain embodiments, the protective matrix includes a second carbohydrate chosen from: inulin, polydextrose, galactooligosaccharide, fructooligosaccharide, starch, maltodextrin having a dextrose equivalent of greater than about 8, and any combination thereof.

In some embodiments, the stabilization mixture may comprise between about 50 and about 80 grams of a first carbohydrate per 100 grams of the mixture on a dry basis; between about 60 and about 70 grams of a first carbohydrate per 100 grams of the mixture on a dry basis; or between about 65 and about 70 grams of a first carbohydrate per 100 grams of the mixture on a dry basis. The first carbohydrate may be chosen from: sucrose, maltose, lactose, trehalose, maltotriose, maltodextrin having a dextrose equivalent of about 2 to about 6, and any combination thereof.

The stabilization mixture may also comprise between about 1 and about 10 grams of a second carbohydrate per 100 grams of the mixture on a dry basis; between about 4 and about 6 grams of a second carbohydrate per 100 grams of the mixture on a dry basis; or about 5 grams of a second carbohydrate per 100 grams of the mixture on a dry basis. In some embodiments, the second carbohydrate is chosen from: inulin, polydextrose, galactooligosaccharide, fructooligosaccharide, starch, maltodextrin having a dextrose equivalent of greater than about 8, and any combination thereof.

A further component of the stabilization mixture can be a compound binder (also referred to as a gelling agent), which may act as a thickener and produce a gel-like consistency. Compound binders that may be included in the protective matrix of the present disclosure include alginates, such as sodium alginate, pectin, chitosan, carboxymethylcellulose, and mixtures thereof, among others. The incorporation of the compound binder provides for the formation of a viscous consistency providing for efficient matrix formation and a structural quality suitable for subsequent drying.

A compound binder can, in some embodiments, form a gum-like material and increase the viscosity of mixtures to which it is added. Additionally, the compound binder may also provide for greater ease in mixing of the components together. For instance, sodium alginate may also possess emulsifier characteristics.

In some embodiments, the stabilization mixture may comprise LM pectin, HM pectin, VL pectin, or any mixture thereof. The included pectin may be soluble in water.

Pectins for use herein typically have a peak molecular weight of 8,000 Daltons or greater. The pectins of the present disclosure have a preferred peak molecular weight of between 8,000 and about 500,000, more preferred is between about 10,000 and about 200,000 and most preferred is between about 15,000 and about 100,000 Daltons. In some embodiments, the pectin of the present disclosure may be hydrolyzed pectin. In certain embodiments, the protective matrix comprises hydrolyzed pectin having a molecular weight less than that of intact or unmodified pectin. The hydrolyzed pectin of the present disclosure can be prepared by any means known in the art to reduce molecular weight. Examples of said means are chemical hydrolysis, enzymatic hydrolysis and mechanical shear. A preferred means of reducing the molecular weight is by alkaline or neutral hydrolysis at elevated temperature. In some embodiments, the protective matrix comprises partially hydrolyzed pectin. In certain embodiments, the partially hydrolyzed pectin has a molecular weight that is less than that of intact or unmodified pectin but more than 3,300 Daltons.

The stabilization mixture may comprise between about 0.5 and about 5 grams of a compound binder, such as sodium alginate and/or pectin, per 100 grams of the mixture on a dry basis. In certain embodiments, the stabilization mixture comprises between about 1 and about 3 grams of a compound binder per 100 grams of the mixture on a dry basis. And in an embodiment, the stabilization mixture comprises about 2 grams of a compound binder per 100 grams of the mixture on a dry basis.

Moreover, the stabilization mixture may also comprise at least one starch, source of starch and/or starch component. In some embodiments, the stabilization mixture may comprise native or modified starches, such as, for example, waxy corn starch, waxy rice starch, waxy potato starch, waxy tapioca starch, corn starch, rice starch, potato starch, tapioca starch, wheat starch or any mixture thereof.

The stabilization mixture may also include additional ingredients that provide further benefits to either the probiotic or the individual ingesting the stabilized probiotic. These ingredients may comprise minerals, vitamins, antioxidants, trace elements, sterols, antioxidants, fatty acids, functional molecules, and any combination thereof. Other ingredients may include resistant starches, high amylose starches, guar, and locust bean gum, agar, xanthan, carrageenans, glucans, and any combination thereof.

In some embodiments, the stabilization mixture may comprise between about 5 and about 90 grams of probiotic and/or other biological material per 100 grams of the mixture on a dry basis. In some embodiments, the stabilization mixture comprises between about 50 and about 90 grams of probiotic and/or other biological material per 100 grams of the stabilization mixture. In certain embodiments, the stabilization mixture comprises between about 9 and about 12 grams of probiotic and/or other biological material per 100 grams of the mixture on a dry basis. And in an embodiment, the stabilization mixture comprises from about 10.2 to about 11.4 grams of probiotic and/or other biological material per 100 grams of the mixture on a dry basis. In another embodiment, the concentration of the probiotic, for instance LGG, in the protective matrix is from about 1×10⁶ to about 1×10¹⁴ cfu per gram of the protective matrix, more preferably from about 1×10⁹ to about 1×10¹¹ cfu per gram of the protective matrix.

The stabilization mixture may be used to provide stability to a probiotic organism which may exert a beneficial effect on the health and welfare of individuals. Examples of suitable probiotics include but are not limited to yeasts such as Saccharomyces cereviseae, molds such as Aspergillus, Rhizopus, Mucor, and bacteria such as Lactobacillus. Specific examples of suitable probiotic microorganisms are: Aspergillus niger, A. oryzae, Bacillus coagulans, B. lentus, B. licheniformis, B. mesentericus, B. pumilus, B. subtilis, B. natto, Bifidobacterium adolescentis, B. animalis, B. breve, B. bifidum, B. infantis, B. lactis, B. longum, B. longum BB536, B. longum AH1206 (NCIMB: 41382), B. breve AH1205 (NCIMB: 41387), B. infantis 35624 (NCIMB: 41003), B. longum AH1714 (NCIMB 41676), B. animalis subsp. lactis BB-12 (DSM No. 10140), B. pseudolongum, B. thermophilum, Candida pintolepesii, Clostridium butyricum, Enterococcus cremoris, E. diacetylactis, E. faecium, E. intermedius, E. lactis, E. muntdi, E. thermophilus, Lactobacillus acidophilus, L. alimentarius, L. amylovorus, L. crispatus, L. brevis, L. case, L. curvatus, L. cellobiosus, L. delbrueckii ss. bulgaricus, L. farciminis, L. fermenturn, L. gasseri, L. helveticus, L. lactis, L. plantarum, L. johnsonii, L. reuteri, L. rhamnosus, Lactobacillus rhamnosus GG (ATCC number 53103), L. sakei, L. salivarius and any combination thereof. In an embodiment, the stabilized probiotic(s) may be viable or non-viable. The stabilized probiotics useful in the present disclosure may be naturally-occurring, synthetic or developed through the genetic manipulation of organisms, whether such new source is now known or later developed.

In an embodiment of the present disclosure Lactobacillus rhamnosus GG is utilized as a probiotic that may be stabilized by the protective matrix of the present disclosure. Lactobacillus rhamnosus GG is described in U.S. Pat. No. 4,839,281, issued to Sharwood et al., which is hereby incorporated by reference in its entirety. Notably, Sharwood et al. describes Lactobacillus rhamnosus GG as being a species in which the bacteria have avid adherence to intestinal cells while being simultaneously able to survive at low pHs and produce large amounts of lactic acid.

The selected probiotic is preferably concentrated to a wet paste-like consistency prior to combining with the stabilization mixture of the present disclosure. Starting with probiotics in dry form is also an alternative. Concentration levels of selected probiotics include concentrations of from about 3× to about 20× though may include lesser or greater concentrations depending upon the specific probiotic biomass and subsequent processing steps.

Generally, the preparation of a stabilized probiotic includes the steps of concentrating the selected probiotic or probiotics; providing components of the stabilization mixture in desired quantities; mixing the stabilization mixture with the concentrated probiotic; drying the stabilized probiotic and either packaging or combining the stabilized probiotic into a nutritional product, such as an infant formula.

In some embodiments, the present disclosure is directed to a method for protecting a viable probiotic for use in a nutritional composition, the method may include the steps of providing a viable probiotic, preparing a protective matrix for the probiotic by blending (i) a phospholipid component and (ii) a glyceride component and any combination thereof, then combining the viable probiotic, the protective matrix and water to produce a mixture and drying the mixture to a final moisture content of about 4% or less, and further adding the dried mixture to a powdered nutritional product or to a capsule.

In optimizing the stabilization for probiotic, the multiple constituents may be varied in some embodiments as described herein and as shown in Tables 1-4. In some embodiments, the lipid may comprise from about 10% to 50% (w/w) of the stabilization mixture. In some embodiments, the stabilization mixture may comprise about 5% to about 25% (w/w) of a phospholipid component, and from about 5% to about 25% (w/w) of a glyceride component. In other embodiments, the stabilization mixture may comprise from about 5% to about 25% (w/w) of a phospholipid component, from about 2.5 to about 12.5% (w/w) of a glyceride component, and from about 2.5% to about 12.5% (w/w) of an additional/other lipid component. In still further embodiments, the total lipids of the stabilization mixture may comprise from about 3% to about 17% (w/w) of a phospholipid component, from about 3 to about 17% (w/w) of a glyceride component, and from about 3% to about 17% (w/w) of an additional/other lipid component.

The stabilized probiotic may be packaged and sold commercially or may be instead combined with a variety of nutritional products or encapsulated with other functional components, such as docosahexaenoic acid. Such nutritional products may include both infant formulas and children's products useful for applications where one desires to incorporate a probiotic into a nutritional product that necessitates an improved shelf-life and stability.

Table 1 presents a sample embodiment of a stabilized probiotic mixture/protective matrix according to the present disclosure.

TABLE 1
An embodiment of the protective matrix

| Ingredient | Grams per 100 g (wet basis) |
|---|---|
| Probiotic (LGG, AH1206 or 35624) | 50-90 |
| Phospholipid(s) | 5-25 |
| Glyceride(s) | 5-25 |

Table 2 presents a sample embodiment of a stabilized probiotic mixture/protective matrix according to the present disclosure.

TABLE 2
An embodiment of the protective matrix

| Ingredient | Grams per 100 g (wet basis) |
|---|---|
| Probiotic (LGG, AH1206 or 35624) | 50-90 |
| Total Lipid(s) | 10-50 |
| Phospholipid(s) | 5-25 |
| Glyceride(s) | optional |
| Other lipid (s) | 5-25 |

Table 3 presents yet another example embodiment of a stabilized probiotic mixture/protective matrix according to the present disclosure.

TABLE 3
An embodiment of the protective matrix

| Ingredient | Grams per 100 g (wet basis) |
|---|---|
| Probiotic (LGG, AH1206 or 35624) | 50-90 |
| Total Lipid(s) | 10-50 |
| Phospholipid(s) | 5-25 |
| Glyceride(s) | 2.5-12.5 |
| Other lipid(s) | 2.5-12.5 |

Table 4 also provides an example embodiment of a stabilized probiotic mixture/protective matrix according to the present disclosure.

TABLE 4
An embodiment of the protective matrix

| Ingredient | Grams per 100 g (dry basis) |
|---|---|
| Probiotic (LGG, AH1206 or 35624) | 90-50 |
| Total Lipid(s) | 10-50 |
| Phospholipid(s) | 3.33-16.7 |
| Glyceride(s) | 3.33-16.7 |
| Other Lipid(s) | 3.33-16.7 |

Nutritional Products for Combination with a Stabilized Probiotic

A stabilized probiotic prepared as described hereinabove may be combined with a nutritional product to form a novel nutritional composition.

For example, the stabilized probiotic may be combined with a nutritional product, such as an infant formula or children's nutritional product, to form a stabilized nutritional composition. In another embodiment, the stabilized probiotic may be combined with a human milk fortifier, which is added to human milk in order to enhance the nutritional value of human milk.

Further, the stabilized probiotic of the disclosure may be combined with a nutritional product that provides minimal, partial, or total nutritional support. Such nutritional product(s) may be nutritional supplements or meal replacements. Indeed, the stabilized probiotic can be intermixed with food or other nutritional products prior to ingestion by a subject.

The nutritional product for combination with the stabilized probiotic may, but need not, be nutritionally complete. Likewise, the combination of the stabilized probiotic with a nutritional product may produce a nutritional composition that is nutritionally complete. In an embodiment, the nutritional composition of the disclosure is nutritionally complete and contains suitable types and amounts of lipid, carbohydrate, protein, vitamins and minerals.

The stabilized probiotic created by the present disclosure may be combined with a nutritional product provided in any form known in the art, including a powder, a gel, a suspension, a paste, a solid, a liquid, a liquid concentrate, or a ready-to-use product. In one combination, the nutritional product is an infant formula, especially an infant formula adapted for use as sole source nutrition for an infant.

The nutritional products described for combining with the stabilized probiotic may be administered enterally.

### Nutritional Compositions Comprising Stabilized Probiotics

Again, a stabilized/protected probiotic prepared as described above may be combined with a nutritional product to form a novel nutritional composition.

The nutritional composition may comprise any additional fat or lipid source that is known or used in the art, including but not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palmolein, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof. The amount of lipid or fat in the nutritional composition typically varies from about 1 to about 7 g/100 kcal.

Further, the nutritional composition may comprise a source of bovine milk protein. The source of bovine milk protein may include, but is not limited to, milk protein powders, milk protein concentrates, milk protein isolates, nonfat milk solids, nonfat milk, nonfat dry milk, whey protein, whey protein isolates, whey protein concentrates, sweet whey, acid whey, casein, acid casein, caseinate (e.g. sodium caseinate, sodium calcium caseinate, calcium caseinate) and any combination thereof.

In certain embodiments, the nutritional composition may comprise intact protein. In other embodiments, the proteins of the nutritional composition are provided as a combination of both intact proteins and partially hydrolyzed proteins, with a degree of hydrolysis of from about 4% and 10%. Certain of these embodiments can be extremely hypoallergenic, as both the stabilizer and the protein of the nutritional product contain only hydrolyzed protein. In yet another embodiment, the nutritional composition may be supplemented with glutamine-containing peptides.

The whey:casein ratio of the protein source of the nutritional composition may be similar to that found in human breast milk. In an embodiment, the protein source of the nutritional composition comprises from about 40% to about 80% whey protein. In another embodiment, the protein source may comprise from about 20% to about 60% caseins. The amount of protein in a nutritional composition typically varies from about 1 to about 7 g/100 kcal.

In other embodiments the nutritional composition comprises lactoferrin, which retains its stability and activity in the human gut against certain undesirable bacterial pathogens.

The nutritional composition described herein can, in some embodiments, also comprise non-human lactoferrin, non-human lactoferrin produced by a genetically modified organism and/or human lactoferrin produced by a genetically modified organism. Lactoferrin is generally described as an 80 kilodalton glycoprotein having a structure of two nearly identical lobes, both of which include iron binding sites. As described in “Perspectives on Interactions Between Lactoferrin and Bacteria” which appeared in the publication BIOCHEMISTRY AND CELL BIOLOGY, pp 275-281 (2006), lactoferrin from different host species may vary in an amino acid sequence though commonly possesses a relatively high isoelectric point with positively charged amino acids at the end terminal region of the internal lobe. Lactoferrin has been recognized as having bactericidal and antimicrobial activities. In at least one embodiment, the lactoferrin is bovine lactoferrin.

Surprisingly, the forms of lactoferrin included herein maintain relevant activity even if exposed to a low pH (i.e., below about 7, and even as low as about 4.6 or lower) and/or high temperatures (i.e., above about 65° C., and as high as about 120° C., conditions which would be expected to destroy or severely limit the stability or activity of human lactoferrin or recombinant human lactoferrin. These low pH and/or high temperature conditions can be expected during certain processing regimen for nutritional compositions of the types described herein, such as pasteurization.

In one embodiment, lactoferrin is present in the nutritional composition in an amount of from about 5 mg/100 kcal to about 16 mg/100 kcal. In another embodiment, lactoferrin is present in an amount of about 9 mg/100 kcal to about 14 mg/100 kcal. In still further embodiments, the nutritional composition may comprise from about 2 mg to about 200 mg lactoferrin per 100 kcal. And in certain embodiments, the nutritional composition may comprise between about 90 mg and about 148 mg lactoferrin per 100 kcal.

The nutritional composition may also contain TGF-β. In some embodiments, the level of TGF-β may be from about 0.0150 (pg/μg) ppm to about 0.1000 (pg/μg) ppm. In other embodiments, the level of TGF-β in final composition including a stabilized probiotic is from about 0.0225 (pg/μg) ppm to about 0.0750 (pg/μg) ppm.

In some embodiments of the nutritional composition, the level of TGF-β is from about 2500 pg/mL to about 10,000 pg/mL, more preferably from about 3000 pg/mL to about 8000 pg/mL. In an embodiment, the ratio of TGF-β1:TGF-β2 is in the range of about 1:1 to about 1:20, or, more particularly, in the range of about 1:5 to about 1:15.

In some embodiments, the bioactivity of TGF-β in a nutritional composition is enhanced by the addition of a bioactive whey fraction. Any bioactive whey fraction known in the art may be used in such embodiments provided it achieves the intended result. In an embodiment, this bioactive whey fraction may be a whey protein concentrate. In a particular embodiment, the whey protein concentrate may be Salibra® 800, available from Glanbia Nutritionals.

The nutritional composition may comprise an amount of probiotic in addition to the stabilized probiotic. When the stabilized probiotic is combined with the nutritional product, the resulting nutritional composition may include a total amount of probiotics effective to provide from about 1×10⁴ to about 1×10¹⁰ colony forming units (cfu) per kg body weight per day to a subject. In other embodiments, the amount of the probiotic may vary from about 1×10⁶ to about 1×10⁹ cfu per kg body weight per day. In even further embodiments, the nutritional composition may include an amount of probiotics effective to provide about 1×10⁶ cfu per kg body weight per day.

In certain embodiments, the nutritional composition of the present disclosure comprises between about 1×10⁶ cfu probiotic and about 1×10¹⁰ cfu per 100 kcal of the composition. In some embodiments, the amount of probiotic may be in the range of about 1×10⁶ cfu to about 1×10⁹ cfu per 100 kcal of the composition. Additionally, the nutritional composition may include non-stabilized probiotics, with the final composition including some stabilized probiotics and some non-stabilized probiotics.

The nutritional composition may further comprise at least one prebiotic. The term “prebiotic” as used herein refers to indigestible food ingredients that exert health benefits upon the host. Such health benefits may include, but are not limited to, selective stimulation of the growth and/or activity of one or a limited number of beneficial gut bacteria, stimulation of the growth and/or activity of ingested probiotic (stabilized or not) microorganisms, selective reduction in gut pathogens, and favorable influence on gut short chain fatty acid profile. Such prebiotics may be naturally-occurring, synthetic, or developed through the genetic manipulation of organisms and/or plants, whether such new source is now known or developed later. Prebiotics may include oligosaccharides, polysaccharides, and other prebiotics that contain fructose, xylose, soya, galactose, glucose and mannose. More specifically, prebiotics useful in the present disclosure may include lactulose, lactosucrose, raffinose, gluco-oligosaccharide, inulin, polydextrose, polydextrose powder, galacto-oligosaccharide, fructo-oligosaccharide, isomalto-oligosaccharide, soybean oligosaccharides, lactosucrose, xylo-oligosaccharide, chito-oligosaccharide, manno-oligosaccharide, aribino-oligosaccharide, siallyl-oligosaccharide, fuco-oligosaccharide, and gentio-oligosaccharides, and combinations thereof.

In some embodiments, the total amount of prebiotics present in the nutritional composition may be from about 1.0 g/L to about 10.0 g/L of the composition (in the liquid form). In certain embodiments, the total amount of prebiotics present in the nutritional composition may be from about 2.0 g/L and about 8.0 g/L of the composition.

The nutritional composition may comprise polydextrose (PDX). If polydextrose is used as a prebiotic, the amount of polydextrose in the nutritional composition may, in an embodiment, be within the range of from about 1.0 g/L to about 4.0 g/L. If polydextrose is used as a prebiotic, the amount of polydextrose in the nutritional product may, in an embodiment of the composition including stabilized probiotics, be within the range of from about 0.1 mg/100 kcal to about 0.5 mg/100 kcal. In another composition, the amount of polydextrose may be about 0.3 mg/100 kcal. At least 20% of the prebiotics should, in a preferred embodiment, comprise polydextrose (PDX).

In certain embodiments, the nutritional composition comprises galacto-oligosaccharide. The amount of galacto-oligosaccharide in the nutritional composition may be from about 0.2 mg/100 kcal to about 1.0 mg/100 kcal. In other embodiments, the amount of galacto-oligosaccharide in the nutritional composition may be from about 0.1 mg/100 kcal to about 0.5 mg/100 kcal. Galacto-oligosaccharide and polydextrose may also be supplemented into the nutritional composition in a total amount of about 0.6 mg/100 kcal.

In some embodiments, the nutritional composition comprises an additional carbohydrate source, that is, a carbohydrate source provided in addition to the other carbohydrates described throughout the present disclosure. Suitable additional carbohydrate sources can be any used in the art, e.g., lactose, glucose, fructose, corn syrup solids, maltodextrins, sucrose, starch, rice syrup solids, and the like. The amount of additional carbohydrate in the nutritional composition typically can vary from about 5 g and about 25 g/100 kcal. In some embodiments, the amount of carbohydrate is between about 6 g and about 22 g/100 kcal. In other embodiments, the amount of carbohydrate is between about 12 g and about 14 g/100 kcal.

The nutritional composition may contain a source of long chain polyunsaturated fatty acids (LCPUFAs) which comprise docosahexaenoic acid (DHA). Other suitable LCPUFAs include, but are not limited to, α-linoleic acid, γ-linoleic acid, linoleic acid, linolenic acid, eicosapentaenoic acid (EPA) and arachidonic acid (ARA).

In some embodiments, the nutritional composition may be supplemented with both DHA and ARA, and the weight ratio of ARA:DHA may be from about 1:3 to about 9:1. In certain embodiments the ARA:DHA ratio is from about 1:2 to about 4:1.

The amount of long chain polyunsaturated fatty acids in the nutritional composition may vary from about 5 mg/100 kcal to about 100 mg/100 kcal, more preferably from about 10 mg/100 kcal to about 50 mg/100 kcal.

Moreover, a nutritional composition may be supplemented with oils containing DHA and ARA using standard techniques known in the art. As an example, the oils containing DHA and ARA may be added to a nutritional composition by replacing an equivalent amount of the rest of the overall fat blend normally present in the nutritional composition.

If utilized, the source of DHA and ARA may be any source known in the art such as marine oil, fish oil, single cell oil, egg yolk lipid, and brain lipid. In some compositions, the DHA and ARA are sourced from the single cell Martek oil, DHASCO®, or variations thereof. The DHA and ARA can be in natural form, provided that the remainder of the LCPUFA source does not result in any substantial deleterious effect on the infant. Alternatively, the DHA and ARA can be used in refined form.

In an embodiment of the nutritional composition, sources of DHA and ARA are single cell oils as taught in U.S. Pat. Nos. 5,374,567; 5,550,156; and 5,397,591, the disclosures of which are incorporated herein in their entirety by reference.

In certain embodiments, the nutritional composition may be a milk-based nutritional composition that provides physiochemical and physiological benefits. As is known in the art, bovine milk protein comprises two major components: acid soluble whey protein and acid insoluble casein, with the latter representing about 80% of the total protein content of bovine milk. Upon entering the acidic environment of the stomach, casein precipitates and complexes with minerals forming semi-solid curds of varying size and firmness. Softer, smaller curds are easier for the body to digest than larger, harder curds. Curd formation may be an important consideration in the development of nutritional compositions, including, but not limited to infant formulas, medical foods, and premature infant formulas. As such, stabilized probiotics may be combined with compositions that include softer and smaller curds than standard infant formulas.

One or more vitamins and/or minerals may also be added in to the nutritional composition in amounts sufficient to supply the daily nutritional requirements of a subject. It is to be understood by one of ordinary skill in the art that vitamin and mineral requirements will vary, for example, based on the age of the child. For instance, an infant may have different vitamin and mineral requirements than a child between the ages of one and thirteen years. Thus, the embodiments are not intended to limit the nutritional composition to a particular age group but, rather, to provide a range of acceptable vitamin and mineral components.

The nutritional composition may optionally include, but is not limited to, one or more of the following vitamins or derivations thereof: vitamin B₁ (thiamin, thiamin pyrophosphate, TPP, thiamin triphosphate, TTP, thiamin hydrochloride, thiamin mononitrate), vitamin B₂ (riboflavin, flavin mononucleotide, FMN, flavin adenine dinucleotide, FAD, lactoflavin, ovoflavin), vitamin B₃ (niacin, nicotinic acid, nicotinamide, niacinamide, nicotinamide adenine dinucleotide, NAD, nicotinic acid mononucleotide, NicMN, pyridine-3-carboxylic acid), vitamin B₃-precursor tryptophan, vitamin B₆ (pyridoxine, pyridoxal, pyridoxamine, pyridoxine hydrochloride), pantothenic acid (pantothenate, panthenol), folate (folic acid, folacin, pteroylglutamic acid), vitamin B₁₂ (cobalamin, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D₃, 1,25,-dihydroxyvitamin D), vitamin E (α-tocopherol, α-tocopherol acetate, α-tocopherol succinate, α-tocopherol nicotinate, α-tocopherol), vitamin K (vitamin K₁, phylloquinone, naphthoquinone, vitamin K₂, menaquinone-7, vitamin K₃, menaquinone-4, menadione, menaquinone-8, menaquinone-8H, menaquinone-9, menaquinone-9H, menaquinone-10, menaquinone-11, menaquinone-12, menaquinone-13), choline, inositol, β-carotene and any combinations thereof.

Further, the nutritional composition may optionally include, but is not limited to, one or more of the following minerals or derivations thereof: boron, calcium, calcium acetate, calcium gluconate, calcium chloride, calcium lactate, calcium phosphate, calcium sulfate, chloride, chromium, chromium chloride, chromium picolonate, copper, copper sulfate, copper gluconate, cupric sulfate, fluoride, iron, carbonyl iron, ferric iron, ferrous fumarate, ferric orthophosphate, iron trituration, polysaccharide iron, iodide, iodine, magnesium, magnesium carbonate, magnesium hydroxide, magnesium oxide, magnesium stearate, magnesium sulfate, manganese, molybdenum, phosphorus, potassium, potassium phosphate, potassium iodide, potassium chloride, potassium acetate, selenium, sulfur, sodium, docusate sodium, sodium chloride, sodium selenate, sodium molybdate, zinc, zinc oxide, zinc sulfate and mixtures thereof. Non-limiting exemplary derivatives of mineral compounds include salts, alkaline salts, esters and chelates of any mineral compound.

The minerals can be added to nutritional compositions in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals can be added as known within the art.

The nutritional composition of the present disclosure may optionally include one or more of the following flavoring agents, including, but not limited to, flavored extracts, volatile oils, cocoa or chocolate flavorings, peanut butter flavoring, cookie crumbs, vanilla or any commercially available flavoring. Examples of useful flavorings include, but are not limited to, pure anise extract, imitation banana extract, imitation cherry extract, chocolate extract, pure lemon extract, pure orange extract, pure peppermint extract, honey, imitation pineapple extract, imitation rum extract, imitation strawberry extract, or vanilla extract; or volatile oils, such as balm oil, bay oil, bergamot oil, cedarwood oil, cherry oil, cinnamon oil, clove oil, or peppermint oil; peanut butter, chocolate flavoring, vanilla cookie crumb, butterscotch, toffee, and mixtures thereof. The amounts of flavoring agent can vary greatly depending upon the flavoring agent used. The type and amount of flavoring agent can be selected as is known in the art.

The nutritional composition of the present disclosure may optionally include one or more emulsifiers that may be added for stability of the final product. Examples of suitable emulsifiers include, but are not limited to, lecithin (e.g., from egg or soy), alpha lactalbumin and/or mono- and di-glycerides, and mixtures thereof. Other emulsifiers are readily apparent to the skilled artisan and selection of suitable emulsifier(s) will depend, in part, upon the formulation and final product. In some embodiments, nutritional compositions of the present disclosure may comprise emulsifiers such as citric acid esters of mono- and/or diglycerides, diacetyl tartaric acid esters of mono- and/or diglycerides, and/or octenyl succinic anhydride modified starches.

The nutritional composition of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The nutritional composition of the present disclosure may optionally include one or more stabilizers. Suitable stabilizers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, and mixtures thereof.

The nutritional composition of the present disclosure may further include at least one additional phytonutrient, that is, another phytonutrient component in addition to the pectin, starch or other phytonutrient components described herein. Phytonutrients, or their derivatives, conjugated forms or precursors, that are identified in human milk are preferred for inclusion in the nutritional composition. For example, in some embodiments, the nutritional composition of the present disclosure may comprise, in an 8 fl. oz. (236.6 mL) serving, between about 80 and about 300 mg anthocyanins, between about 100 and about 600 mg proanthocyanidins, between about 50 and about 500 mg flavan-3-ols, or any combination or mixture thereof. In other embodiments, the nutritional composition comprises apple extract, grape seed extract, or a combination or mixture thereof. Further, the at least one phytonutrient of the nutritional composition may be derived from any single or blend of fruit, grape seed and/or apple or tea extract(s).

Examples of additional phytonutrients suitable for the nutritional composition include, but are not limited to, anthocyanins, proanthocyanidins, flavan-3-ols (i.e. catechins, epicatechins, etc.), flavanones, flavonoids, isoflavonoids, stilbenoids (i.e. resveratrol, etc.) proanthocyanidins, anthocyanins, resveratrol, quercetin, curcumin, and/or any mixture thereof, as well as any possible combination of phytonutrients in a purified or natural form. Certain components, especially plant-based components of the nutritional compositions may provide a source of phytonutrients.

The phytonutrient component of the nutritional composition may also comprise naringenin, hesperetin, anthocyanins, quercetin, kaempferol, epicatechin, epigallocatechin, epicatechin-gallate, epigallocatechin-gallate or any combination thereof. In certain embodiments, the nutritional composition comprises between about 50 and about 2000 nmol/L epicatechin, between about 40 and about 2000 nmol/L epicatechin gallate, between about 100 and about 4000 nmol/L epigallocatechin gallate, between about 50 and about 2000 nmol/L naringenin, between about 5 and about 500 nmol/L kaempferol, between about 40 and about 4000 nmol/L hesperetin, between about 25 and about 2000 nmol/L anthocyanins, between about 25 and about 500 nmol/L quercetin, or a mixture thereof. Furthermore, the nutritional composition may comprise the metabolite(s) of a phytonutrient or of its parent compound, or it may comprise other classes of dietary phytonutrients, such as glucosinolate or sulforaphane. In certain embodiments, the nutritional composition comprises carotenoids, such as lutein, zeaxanthin, astaxanthin, lycopene, beta-carotene, alpha-carotene, gamma-carotene, and/or beta-cryptoxanthin.

The nutritional composition may also comprise isoflavonoids and/or isoflavones. Examples include, but are not limited to, genistein (genistin), daidzein (daidzin), glycitein, biochanin A, formononetin, coumestrol, irilone, orobol, pseudobaptigenin, anagyroidisoflavone A and B, calycosin, glycitein, irigenin, 5-O-methylgenistein, pratensein, prunetin, psi-tectorigenin, retusin, tectorigenin, iridin, ononin, puerarin, tectoridin, derrubone, luteone, wighteone, alpinumisoflavone, barbigerone, di-O-methylalpinumisoflavone, and 4′-methyl-alpinumisoflavone. Plant sources rich in isoflavonoids, include, but are not limited to, soybeans, psoralea, kudzu, lupine, fava, chick pea, alfalfa, legumes and peanuts.

In an embodiment, the nutritional composition of the present disclosure comprises an effective amount of choline. An effective amount of choline is between about 20 mg choline per 8 fl. oz. (236.6 mL) serving to about 100 mg per 8 fl. oz. (236.6 mL) serving.

The disclosed nutritional composition may additionally comprise a source of β-glucan. Glucans are polysaccharides, specifically polymers of glucose, which are naturally occurring and may be found in cell walls of bacteria, yeast, fungi, and plants. Beta glucans β-glucans) are themselves a diverse subset of glucose polymers, which are made up of chains of glucose monomers linked together via beta-type glycosidic bonds to form complex carbohydrates.

β-1,3-glucans are carbohydrate polymers purified from, for example, yeast, mushroom, bacteria, algae, or cereals. (Stone B A, Clarke A E. Chemistry and Biology of (1-3)-Beta-Glucans. London:Portland Press Ltd; 1993.) The chemical structure of β-1,3-glucan depends on the source of the β-1,3-glucan. Moreover, various physiochemical parameters, such as solubility, primary structure, molecular weight, and branching, play a role in biological activities of β-1,3-glucans. (Yadomae T., Structure and biological activities of fungal beta-1,3-glucans. Yakugaku Zasshi. 2000;120:413-431.)

β-1,3-glucans are naturally occurring polysaccharides, with or without β-1,6-glucose or β-1,4 glucose branched side chains, that are found in the cell walls of a variety of plants, yeasts, fungi and bacteria.

β-glucans derived from baker's yeast, Saccharomyces cerevisiae, are made up of chains of D-glucose molecules connected by β glycosidic linkages at the 1 and 3 positions, having side chains of glucose attached by β glycosidic linkages at the 1 and 6 positions. Yeast-derived β-glucan is an insoluble, fiber-like, complex sugar having the general structure of a linear chain of glucose units with a β-1,3 backbone interspersed with β-1,6 side chains that are generally 6-8 glucose units in length. More specifically, β-glucan derived from baker's yeast is poly-(1,6)-β-D-glucopyranosyl-(1,3)-β-D-glucopyranose.

Furthermore, β-glucans are well tolerated and do not produce or cause excess gas, abdominal distension, bloating or diarrhea in pediatric subjects. Addition of β-glucan to a nutritional composition for a pediatric subject, such as an infant formula, a growing-up milk or another children's nutritional product, will improve the subject's immune response by increasing resistance against invading pathogens and therefore maintaining or improving overall health.

The nutritional composition of the present disclosure may comprise β-glucan. In some embodiments, the β-glucan is β-1,3;1,6-glucan. In some embodiments, the β-1,3;1,6-glucan is derived from baker's yeast. The nutritional composition may comprise whole glucan particle β-glucan, particulate β-glucan, microparticulate β-glucan, PGG-glucan (poly-1,6-β-D-glucopyranosyl-1,3-β-D-glucopyranose) or any mixture thereof. In some embodiments, microparticulate β-glucan comprises β-glucan particles having a diameter of less than 2 μm.

In some embodiments, the amount of β-glucan present in the composition is at between about 0.010 and about 0.080 g per 100 g of the nutritional composition. In other embodiments, the nutritional composition comprises between about 10 and about 30 mg β-glucan per serving. In another embodiment, the nutritional composition comprises between about 5 and about 30 mg β-glucan per 8 fl. oz. (236.6 mL) serving. In other embodiments, the nutritional composition comprises an amount of β-glucan sufficient to provide between about 15 mg and about 90 mg β-glucan per day. In some embodiments, the nutritional composition may be delivered in multiple doses to reach a target amount of β-glucan delivered to the subject throughout the day.

In some embodiments, the amount of β-glucan in the nutritional composition is between about 3 mg and about 17 mg per 100 kcal. In another embodiment the amount of β-glucan is between about 6 mg and about 17 mg per 100 kcal.

The nutritional composition may be expelled directly into a subject's intestinal tract. In some embodiments, the nutritional composition is expelled directly into the gut. In some embodiments, the composition may be formulated to be consumed or administered enterally under the supervision of a physician and may be intended for the specific dietary management of a disease or condition, such as celiac disease and/or food allergy, for which distinctive nutritional requirements, based on recognized scientific principles, are established by medical evaluation.

The nutritional composition of the present disclosure is not limited to compositions comprising nutrients specifically listed herein. Any nutrients may be delivered as part of the composition for the purpose of meeting nutritional needs and/or in order to optimize the nutritional status in a subject.

The nutritional composition of the present disclosure may be standardized to a specific caloric content, it may be provided as a ready-to-use product, or it may be provided in a concentrated form.

In some embodiments, the nutritional composition of the present disclosure is a growing-up milk. Growing-up milks are fortified milk-based beverages intended for children over 1 year of age (typically from 1-3 years of age, from 4-6 years of age or from 1-6 years of age). Growing-up milks are designed with the intent to serve as a complement to a diverse diet to provide additional insurance that a child achieves continual, daily intake of all essential vitamins and minerals, macronutrients plus additional functional dietary components, such as non-essential nutrients that have purported health-promoting properties.

The exact composition of a nutritional composition according to the present disclosure can vary from market-to-market, depending on local regulations and dietary intake information of the population of interest. In some embodiments, nutritional compositions according to the disclosure include a milk protein source, such as whole or skim milk, plus added sugar and sweeteners to achieve desired sensory properties, and added vitamins and minerals. The fat composition is typically derived from the milk raw materials. Total protein can be targeted to match that of human milk, cow milk or a lower value. Total carbohydrate is usually targeted to provide as little added sugar, such as sucrose or fructose, as possible to achieve an acceptable taste. Typically, Vitamin A, calcium and Vitamin D are added at levels to match the nutrient contribution of regional cow milk. Otherwise, in some embodiments, vitamins and minerals can be added at levels that provide approximately 20% of the dietary reference intake (DRI) or 20% of the Daily Value (DV) per serving. Moreover, nutrient values can vary between markets depending on the identified nutritional needs of the intended population, raw material contributions and regional regulations.

In certain embodiments, the nutritional composition is hypoallergenic. In other embodiments, the nutritional composition is kosher. In still further embodiments, the nutritional composition is a non-genetically modified product. In an embodiment, the nutritional formulation is sucrose-free. The nutritional composition may also be lactose-free. In other embodiments, the nutritional composition does not contain any medium-chain triglyceride oil. In some embodiments, no carrageenan is present in the composition. In other embodiments, the nutritional composition is free of all gums.

Accordingly, by the practice of the present disclosure, stabilized probiotics having heretofore unrecognized stability are prepared. The stabilized bacterial mixture exhibits exceptionally high stability through the use of hydrolyzed mammalian protein, especially hydrolyzed mammalian protein with over 70% of the peptides having a molecular weight of less than 2,000 Daltons. The stabilized probiotics are uniquely effective for nutritional applications with intermediate moisture levels (such as water activity as high as 0.4) where increased shelf life and stability in hot and humid environments are desired. The stabilized probiotics may be packed separately or be combined with any of the embodiments of nutritional compositions described herein.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although preferred embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged both in whole or in part. For example, while methods for the production of a commercially sterile liquid nutritional supplement made according to those methods have been exemplified, other uses are contemplated. Therefore, the spirit and scope of the appended claims should not be limited to the description of the preferred versions contained therein.

What is claimed is:

1. A nutritional composition comprising
a protein source; and
a probiotic stabilized in a protective matrix, the protective matrix comprising,
a. at least one phospholipid; and
b. at least one glyceride.

2. The composition of claim 1, wherein the probiotic comprises viable microbial cells.

3. The composition of claim 2, wherein the viable microbial cells comprise Lactobacillus rhamnosus.

4. The composition of claim 1, wherein the matrix further comprises a carbohydrate source.

5. The composition of claim 1, wherein the matrix further comprises pectin.

6. The composition of claim 1, wherein the at least one phospholipid comprises lecithin.

7. The composition of claim 1, wherein the at least one glyceride comprises a monoglyceride, a diglyceride, or any combination thereof.

8. The composition of claim 1, wherein the nutritional composition is a powdered infant formula.

9. The composition of claim 1, wherein the nutritional composition further comprises at least one additional lipid component.

10. The composition of claim 1, wherein the nutritional composition further comprises a non-viable probiotic.

11. A method for protecting a viable probiotic for use in a powdered nutritional composition, the method comprising:
a. providing a viable probiotic;
b. preparing a protective matrix for the probiotic by blending
i. at least one phospholipid; and
ii. at least one glyceride.
c. combining the viable probiotic, the protective matrix and water to produce a mixture; and
d. drying the mixture of step (c) to a final moisture content of about 4% or less.

12. The method of claim 11, comprising the additional step of adding the dried mixture of step (d) to a powdered nutritional product.

13. The method of claim 11, comprising the additional step of enclosing the dried mixture of step (d) in a capsule.

14. The method of claim 13, wherein the capsule further comprises an amount of docosahexaenoic acid.

15. The method of claim 11, wherein the viable probiotic comprises Lactobacillus rhamnosus.

16. The method of claim 11, wherein the viable probiotic comprises Bifidobacterium longum BB536, Bifidobacterium longum subsp. infantis 35624, Bifidobacterium animalis subsp. lactis BB-12, or any combination thereof.
